(19) United States
(12) Patent Application Publication
(10) Pub. No.: US 2017/0277177 A1
(43) Pub. Date: Sep. 28, 2017

(54) END OF CYCLE POINT NAVIGATION OF A POOL CLEANER

(71) Applicants: Shay Witelson, Kibbutz Yizrael (IL); Yair Hadari, Kibbutz Hulata (IL)

(72) Inventors: Shay Witelson, Kibbutz Yizrael (IL); Yair Hadari, Kibbutz Hulata (IL)

(21) Appl. No.: 15/463,161

(22) Filed: Mar. 20, 2017

Related U.S. Application Data
(60) Provisional application No. 62/311,432, filed on Mar. 22, 2016.

(51) Int. Cl. G05D 1/00; E04H 4/16

(52) U.S. Cl. CPC G05D 1/0016; E04H 4/1654; G05D 1/0044

(57) ABSTRACT

A method for operating a pool cleaner, the method may include receiving, by the pool cleaner, end of cycle location information that defines an end of cycle location; wherein the end of cycle location information is generated by a mobile computer and under a control of a user; and performing multiple cleaning cycles, by the pool cleaner, wherein the performing comprises positioning the pool cleaner, at an end of each cleaning cycle of the multiple cleaning cycles, at the end of cycle location.

### CROSS REFERENCE

This application claims the priority of U.S. provisional patent Ser. No. 62/311,432 filing date Mar. 22, 2016 which is incorporated herein by reference.

### BACKGROUND

There is a growing need to reduce the human intervention and difficulty in the operation of pool clean with special focus in this invention proposal to provide a novel way to improve and to facilitate with the speedy extraction or the removal of a submerged pool cleaner from the swimming pool.

This is especially suitable for users who do not unnecessarily keep the pool cleaner in their pools for lengthy periods of time. For example, if the pool cleaning cycle has ended and the pool cleaner automatically shuts-off, young children may go for a swim and the user wishes to avoid any tampering with the pool cleaner while the young are swimming.

### SUMMARY

There may be provided a method for operating a pool cleaner, the method may include receiving, by the pool cleaner, end of cycle location information that defines an end of cycle location; wherein the end of cycle location information may be generated by a mobile computer and under a control of a user; and performing multiple cleaning cycles, by the pool cleaner, wherein the performing may include positioning the pool cleaner, at an end of each cleaning cycle of the multiple cleaning cycles, at the end of cycle location.

The receiving may be followed by altering a cleaning program of the pool cleaner to reflect the end of cycle information.

The end of cycle location may be positioned on a bottom of the pool.

The end of cycle location may include a pool wall area.

The end of cycle location may include a bottom pool area and a pool wall area.

The positioning of the pool at the end of cycle location may include moving, at least once, the pool cleaner along the pool wall area.

The method may include cleaning, at least once, the pool wall area while moving, at least once, the pool cleaner along the pool wall area.

The method may include sending by the pool cleaner and to the mobile computer an end of cycle indication, wherein sending occurs during the moving.

The moving, at least once, the pool cleaner along the pool wall area may include performing a predefined number of moving and then parking the pool cleaner at the bottom pool area.

The method may include mapping the pool by the pool cleaner, using at least one sensor of the pool cleaner.

A preforming of each cleaning cycle may include climbing on at least a portion of a pool wall by the pool cleaning robot.

The preforming of each cleaning cycle may include cleaning the at least portion of the pool wall by the pool cleaning robot.

The at least portion of the pool wall may be located outside the end of cycle location.

The climbing on the at least portion of the pool wall may include calibrating at least one sensor of the pool cleaner based on a position of the pool cleaner during the climbing or following the climbing.

There may be provided a method for operating a pool cleaner, the method may include: receiving, by the pool cleaner, end of cycle location information that defines an end of cycle location that may include a bottom pool area and a pool wall area; performing a cleaning cycle, by the pool cleaner, wherein the performing may include moving, at least once, the pool cleaner along the pool wall area.

The method may include cleaning, at least once, the pool wall area while moving, at least once, the pool cleaner along the pool wall area.

The method may include sending by the pool cleaner and to the mobile computer an end of cycle indication, wherein sending occurs during the moving.

The moving, at least once, the pool cleaner along the pool wall area may include performing a predefined number of moving and then parking the pool cleaner at the bottom pool area.

There may be provided a pool cleaner, may include: a housing; an outlet for outputting filtered fluid; an inlet for receiving non-filtered fluid; a controller; a filtering unit; a propulsion system; one or more sensors; and a communication module; wherein the communication module may be configured to receive end of cycle location information that defines an end of cycle location; wherein the end of cycle location information may be generated by a mobile computer and under a control of a user; and wherein the controller may be configured to control multiple cleaning cycles of the pool cleaner; wherein a performing of the multiple cleaning cycles may include positioning the pool cleaner, at an end of each cleaning cycle of the multiple cleaning cycles, at the end of cycle location; wherein each cleaning cycle may include passing the non-filtered fluid through the filtering unit to provide the filtered fluid while moving the pool cleaner by the propagation system.

There may be provided a pool cleaner, may include: a housing; an outlet for outputting filtered fluid; an inlet for receiving non-filtered fluid; a controller; a filtering unit; a propulsion system; one or more sensors; and a communication module; wherein the communication module may be configured to receive end of cycle location information that defines an end of cycle location that may include a bottom pool area and a pool wall area; wherein the controller may be configured to control a cleaning cycle of the pool cleaner; and wherein a performing of the cleaning cycle may include moving, at least once, the pool cleaner along the pool wall area; and passing the non-filtered fluid through the filtering unit to provide the filtered fluid while moving the pool cleaner by the propagation system.

There may be provided a non-transitory computer readable medium that stores instructions that once executed by a pool cleaner, causes the pool cleaner to perform the steps of: receiving end of cycle location information that defines an end of cycle location; wherein the end of cycle location information may be generated by a mobile computer and under a control of a user; and performing multiple cleaning cycles, wherein the performing may include positioning the pool cleaner, at an end of each cleaning cycle of the multiple cleaning cycles, at the end of cycle location.

There may be provided a non-transitory computer readable medium that stores instructions that once executed by a pool cleaner, causes the pool cleaner to perform the steps of: receiving end of cycle location information that defines an end of cycle location that may include a bottom pool area and a pool wall area; performing a cleaning cycle, and wherein the performing may include moving, at least once, the pool cleaner along the pool wall area.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a pool cleaner that includes one or more sensors according to an embodiment of the invention;

FIG. 2A illustrates an interactive two-dimensional smart screen grid with graph coordinate points in a large commercial pool with menus to choose an end of cycle demarcated point according to an embodiment of the invention;

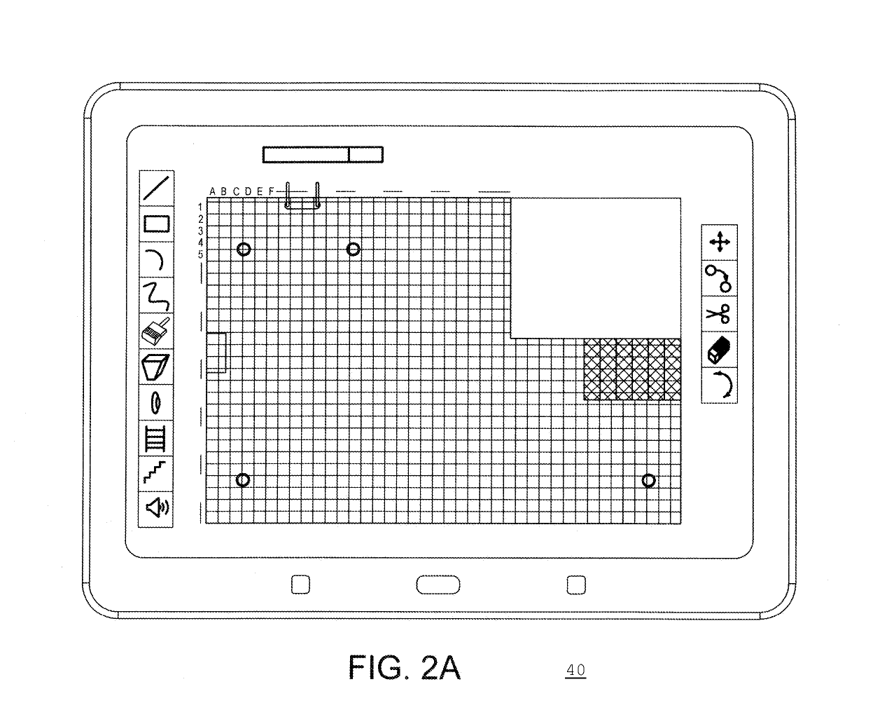

FIG. 2B illustrates an interactive two-dimensional smart screen grid with graph coordinate points in a swimming pool with menus to choose an end of cycle demarcation point according to an embodiment of the invention;

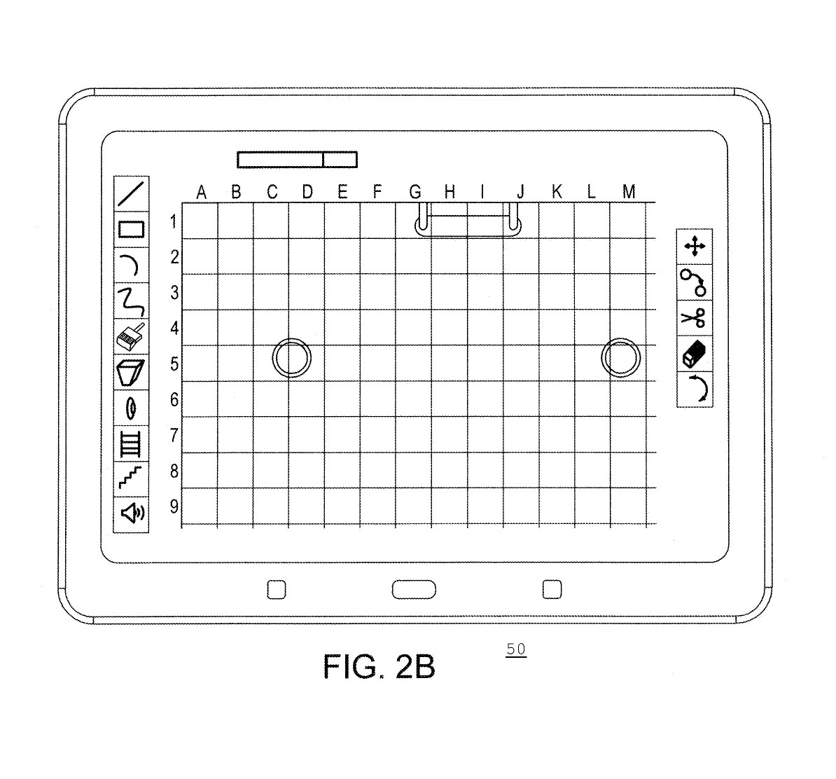

FIG. 3 illustrates a pool, a pool cleaner and a user holding a smart programmable and interactive remote control device with two way communications capabilities according to an embodiment of the invention; the pool cleaner 10 is submerged and coupled via cable 80 to power and/or communication unit 70;

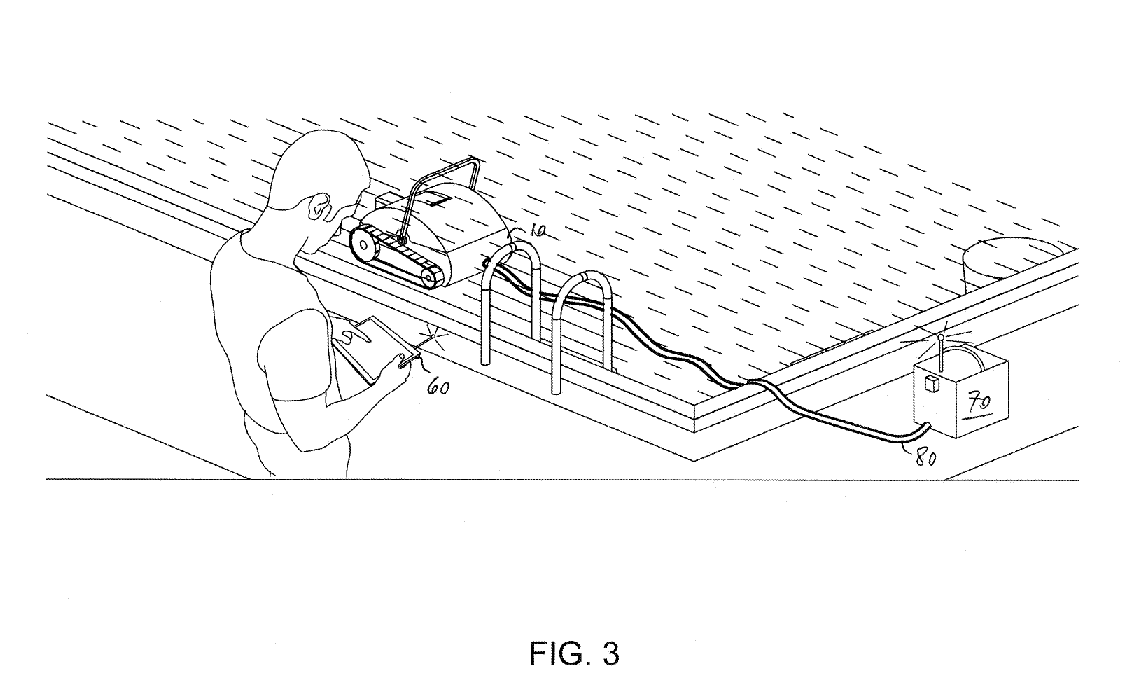

FIG. 4. illustrates a three dimensional view of a pool cleaner 10 within pool 100 where the pool cleaner reaching and awaiting retrieval at its end of cycle demarcation zone that consists of an end of cycle area on the floor, an area near a pool wall or both, according to an embodiment of the invention;

FIG. 5. illustrates a three dimensional view of a pool cleaner 10 within pool 100 where the pool cleaner performs multiple climbs and descents, on the wall, after reaching its end of cycle demarcated zone, awaiting retrieval according to an embodiment of the invention; and

FIG. 6 illustrates a method according to an embodiment of the invention.

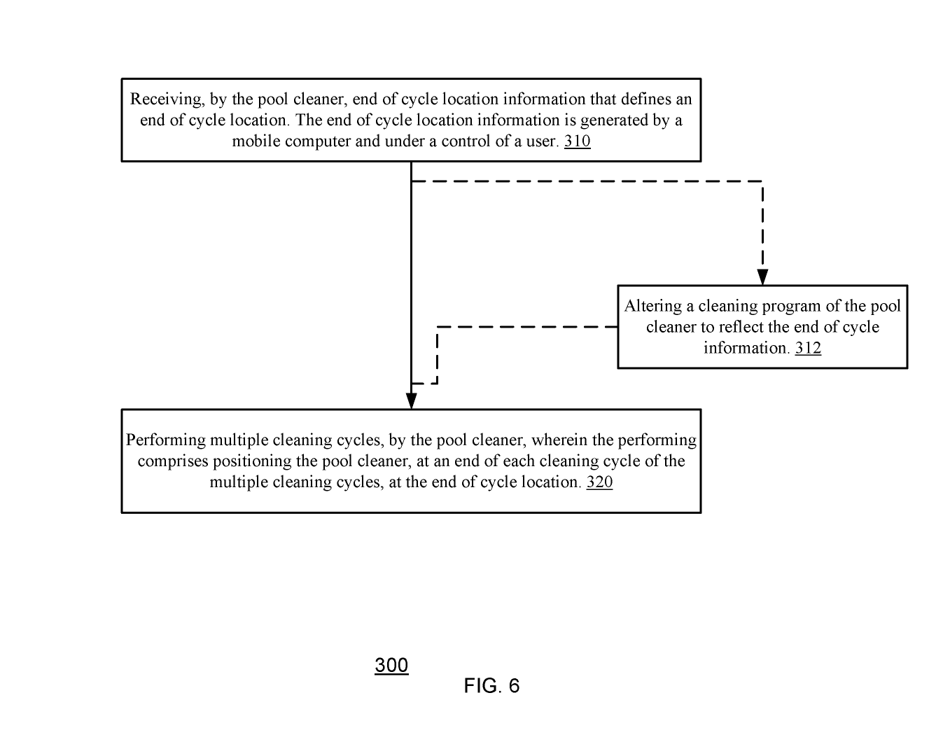

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

Any reference in the specification to a system should be applied mutatis mutandis to a method that can be executed by the system.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

There is provided a pool cleaner that can, autonomously and without human intervention, repeatedly, consistently and automatically position itself in favourable pool locations in order to facilitate the end user's physical actions whilst retrieving or removing the pool cleaner from the pool for servicing or for storage purposes. In this specification the terms “autonomous”, “independent” and “without human intervention” are used in an interchangeable manner.

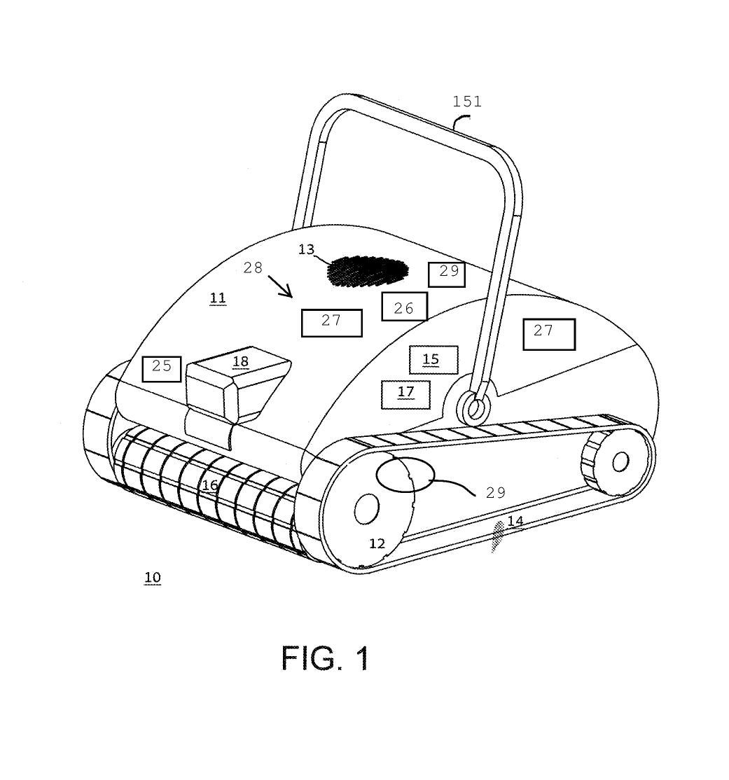

The pool cleaner 10 (see FIG. 1) includes a hollow body 11 (also referred to as housing), and a propulsion system 28 that may include at least one drive motor 27 that allows the hollow body of the pool cleaner to move forward or backward through the wheels 12 (coupled by tracks 14) or caterpillars, it may have at least two wheels or two wheel sets (axles) which connect wheels—from all sides of the hollow body—which is placed parallel to the direction of propagation of the pool cleaner. The pool cleaner may have caterpillars or tracks that are connected to the wheels or a front and/or rear wheel kit. FIG. 1 also illustrates brush wheel 16—although other cleaning elements may be provided.

Additionally, the pool cleaner may include a hydraulic system, which includes: at least one fluid inlet (such as inlet 29—that may be located at the bottom of the pool cleaner—or at another location) wherein the fluid is pumped into the hydraulic system by at least one pump motor 26 and passes through at least one filter of filtering unit 17 to be filtered and to be finally ejected (through opening 13) from the pool cleaner.

The pool cleaner can include a rechargeable battery or be powered by and an external power supply and an electrical cable tethered to the pool cleaner.

The pool cleaner may be governed by controller 15 that may be an on-board control box that performs one or more control functions in conjunction of an electronic PCB/processor that is able to store information or operating software.

Information in the control function may be received from pre-programmed on-board operating software with additional information or parameters inputted from an on-board sensor or a range of sensors that all in all create a pool cleaner controller.

The pool cleaner may include one or more sensors 18 such as one or more speed sensors, one or more RPM sensors, one or more tilt and/or angle sensors, one or more mechanical impact sensors, one or more inertial motion sensors, one or more accelerometers, one or more acoustic sensors, one or more compasses, one or more gyroscopes, one or more gyrocompasses, one or more turbidity sensors, one or more dirt identification sensors, one or more optical sensors such as one or more cameras, one or more infrared cameras, one or more laser beam based sensors and the like.

The pool cleaner may include one or more illumination modules 25 for illuminating one or more areas of the pool—and thus assisting in sensing the vicinity of the pool cleaner by sensors such as the optical sensors. The one or more illumination modules 25 may include one or more light emitting diodes, one or more spot lights, one or more laser illuminators, one or more infrared illuminators, or any other illumination element.

The one or more illumination modules may “cover” areas of different shapes and/or sizes. The one or more sensors may provide detection signals that are processed by the pool cleaner (for example by controller 15) to recognize pool constituents or a pool status parameters such as water chemical compositions, vision conditions, poor or lack of lighting, slippery surfaces and the like.

The one or more sensors 18 and/or the one or more illumination modules 25 may be located at any location. For example—multiple sensors may be positioned at different sides of the housing, at the same side of the housing, on the top of the housing, at the bottom of the housing, near each other (for example—up to five centimetre from each other) or spaced apart from each other. For example—multiple illumination modules may be positioned at different sides of the housing, at the same side of the housing, on the top of the housing, at the bottom of the housing, near each other or spaced apart from each other. Yet for another example—a sensor and an illumination module may be positioned at different sides of the housing, at the same side of the housing, on the top of the housing, at the bottom of the housing, near each other or spaced apart from each other.

Pool cleaner 10 may have interfaces such as handle 151.

The controller 15 may be arranged to provide navigation options that may include movements where the pool cleaner moves back and forth with a preplanned or preprogrammed routing.

It should be noted that even when performing preplanning or pre-programming efforts used or implemented, pool cleaners may still experience a deterioration in their scanning abilities by incrementally shifting from the pre-programmed routing to a random mode where pre-planned routings are deviated from.

The navigation scanning deterioration or shortcomings negatively affect the defining the reaching of an end of cycle location point or demarcated zone on the pool floor. Moreover, it is difficult to reach such an end point consistently and repeatedly from one cleaning cycle to another.

Furthermore, it has been found that there is a lack of consistent repeating of the end-of-cycle positioning of the pool cleaner after each end of each of the predefined cycle-times.

Overcoming the above navigation shortcomings to achieve effective scanning results requires identification of pool constituents such as: poor visibility, out of balance water chemistry, algae growth causing slippery surfaces and the like that may enable to construct an imaginary grid of the entire pool area so that specific imaginary coordinates may be defined in order for a pool cleaner to reach an end of cycle location, point or area.

Pool constituents, in this specification, may encompass any component in a swimming pool that may adversely affect pool movement, navigation, and specific reaching an end of cycle location consistently and repeatedly.

The above controller may be arranged to provide identification of obstacles in the routing in order to provide modes of either of handling such obstacles for evasive manoeuvres from said obstacles or, importantly to this specification, to construct a coordinate imaginary grid that can be depicted on a screen of a portable computer device and be memorized by the pool cleaner controller.

One of the pool cleaner obstacles may be a wall that may be vertical or angled and may completely or partially envelop or surround the entire pool structure. The pool cleaner may identify a meeting with a wall that will automatically implement a program that may be an escape that may be translated into a stop forward trajectory and a reversal of forward movement. It may initiate turning, a wall climbing or a temporary or full stoppage at the base of the wall.

Therefore, included in the at least one sensors may be a “wall sensor” that may be the known tilt sensors or accelerometers that may use the meetings and the vertical travelling on wall inclinations as major navigational pool landmarks or markers within the navigational framework of repeatedly finding and defining the end of cycle point area location on the pool floor. Location of this said point may also be extended to include recognition of the entire vertical wall strip adjacent to the said horizontal end point area.

Walls recognitions, the movement from a horizontal position to a vertical or even a perpendicular position in the pool in relation to the floor is an instrumental navigational aide for identification and memorizing the pool form and contours, recognizing a co-ordinates grid and thereby the definition of the demarcated end of cycle point or area.

It should therefore be stressed, that because the final stoppage point in the pool, namely, the final end of cycle location after a pool cleaning cycle cannot be easily predefined or pre-programmed and cannot be repeatedly and consistently be defined from one new cleaning cycle to the next then the controller 17 may use sensors data and apply one or more algorithms to locate the end of cycle location.

The controller may initiate overcoming navigational corrective action procedures to mitigate navigation in adverse pool conditions so that the pool cleaner may specifically reach an end of cycle location consistently and repeatedly towards the end of each cleaning cycle time.

For a corrective action example, a pool cleaner may slip and deviate away from a planned trajectory towards an end of cycle location due to slippery surfaces pool constituents.

The corrective action may involve processing detection signals from one or more gyroscopes and/or one or more compasses about the bearing of the pool cleaner, and additionally or alternatively processing detection signals from one or more cameras to recognize other constituents such a ladder, a spot lamp or a main drain in order to renew triangulation of actual location to precisely reach the chosen end of cycle location.

Yet as another corrective action example, a pool cleaner may slip and deviate away from a planned trajectory towards an end of cycle location due to bad underwater visibility that limits or eliminates the viable use of an underwater camera.

The controller may initiate a lighting of one or more pool area by the one or more lighting modules. The lighting may cause pool constituents to be visible even in pool visibility conditions.

The controller may, additionally or alternatively, use detection signals of other sensors in order to renew triangulation of actual location to precisely reach the chosen end of cycle location.

The controller may evaluate whether one or more images acquired by the at least one visual sensor disclose one or more pool constitutes—in order to determine whether there is a need to activate the one or more lighting modules.

The evaluation may include image recognition, determining whether the signal to noise ratio of the image is adequate, whether the images are too dark (can be evaluated by measuring grey levels of pixels of the images), and the like.

In any corrective action, the controller may initiate a wall climbing upon a meeting with such a constituent. Wall climbing, due to underwater reduced gravity forces, is an advantage that pool cleaners may have over autonomous garden lawnmowers, home vacuum cleaners and the like.

The clinging to the wall and descent in a vertical position also causes the robot to straighten itself in a defined bearing in relation to the horizontal floor in order to renew effective triangulation of actual location to precisely reach the chosen end of cycle location.

Depending on the in-pool adverse, negative shortcomings caused by pool constituents, corrective actions may initiate a combination of a range of sensory means so that the pool cleaner may reach an end of cycle location consistently and repeatedly during each cleaning cycle.

Furthermore, the pool cleaner may include a communication module 29 that may include a receiver and/or a transmitter—thereby allowing the pool cleaner to participate in and/or control a two-way communications function between the pool cleaner and the end user or operator that may comprise an overriding remote control device.

Such communication may be achieved by means of a fully wireless system where the pool cleaner may emit messages to external, computerized devices. It may be partially wireless where an electric cable may serve as a conduit to an external device such as a power supply.

A remote-control device may be a dedicated OEM supplied device or it may be any of the computers, hand held telephony or tablet devices that comprise operating applications (or “Apps”) that may be installed onto the devices in order to activate special programs or special features in the handling of the pool cleaner.

An application is the MyDolphin application, owned by Maytronics Ltd. the producers of the Dolphin brand pool cleaner that can be downloaded onto a smart device to enable, by means of menus, the usage of numerous functions.

This application, or any other similar application, may be used to generate a screen that presents the design or the contour of the pool.

A co-ordinates graph grid may be provided by means of say numbers or letters or of numbers and letters for example: co-ordinate point 1,G to 1,J and 2,G to 2,J that nominate a specific co-ordinate demarcated point or area in the pool.

Said co-ordinate points may be screen depicted in two or three-dimensional forms to represent a specific demarcated area point on the pool floor and/or on the wall or both to eventually form a end of cycle demarcated corridor zone.

There is provided a pool cleaner (such as a pool cleaning robot) that has end-of-cycle positioning and manoeuvring procedures programming capabilities. Namely, specific programming procedures that will repeatedly and consistently position the pool cleaner at a predefined point in the pool so that the end user does not experience the difficulties of locating the pool cleaner (in murky waters) or the effort involved with pulling at the electrical cable/cord to reel in the pool cleaner a long distance to the waterline so that it may be removed or extracted from the pool.

There may be an application that may be downloaded, similar to but not limited to the My Dolphin application that may possess the end of cycle menu and end of cycle location, where the user activates or implements the default or the pre-programming of an end-of-cycle positioning of his choice in the following manner:
a. The user finds in the smart device or the dedicated remote control device the applicable “end of cycle” menu.
b. In the said menu, a pre-programmed function is located so that the end user may choose the preferred modes for the “end of cycle”. The said modes may comprise a set of “end of cycle communications” modes between the pool cleaner and the end user that will be further explained below.
c. Before or after immersing the pool cleaner inside the pool, the end user may choose the specific “end of cycle” demarcated point or zone in the application and nominate co-ordinate points in the pool on the devices' screen as his preferred entered point of “end of cycle” for the pool cleaner's retrieval or extraction from the pool at the end of the cleaning cycle.
d. There may be two main options in the application for a “end of cycle” point:
   A. At a point on the floor and near a wall: for example—OEM program default “finish” point or demarcated area for the “end of cycle” whereby at the end of cleaning cycle the pool cleaner travels to that finish point that may be at a specifically chosen co-ordinate on the pool floor that will remain as the default end of cycle point. Such a point or demarcated area may preferably be located on the pool floor and near a wall.
   B. In a zone that extends the floor area co-ordinates to include a demarcated exit corridor that also extends from the said floor zone to a demarcated area on the pool's wall up to the pool's waterline. The pool cleaner will continue to actively scrub and clean the said demarcated on the wall corridor a pre-set of times while climbing and descending inside the said demarcated wall area.
e. Depending on the preferred mode of end of cycle the “point of exit” may therefore be a specific demarcated point or a coordinate point on the floor at the bottom of the pool or at a specific demarcated point, against the pool wall up to the waterline, which the end user chooses and pre-sets in the device and in the pool cleaner memories.
f. In practical terms, the end user activates the said app menu where he may reconfirm the default end of cycle program whereby he chooses certain finish point on the floor and near a wall or applying a special wall cleaning procedure on the wall by ticking a YES in a rubric, that may be called floor “finish” or floor “home” or “on wall home”. If the user chooses YES at any of these options, then the pool cleaner will automatically implement any one of the following procedure at end of cycle:
   1) In one embodiment, the pool cleaner will search and identify the said end user pre-defined location of chosen on-the-floor end of cycle demarcated area point and travel to that point. On reaching that point the pool cleaner will automatically shut-off and await its extraction by the end user. A special wireless communication messaging may be defined by the user to be implemented on request notifying the end user that it is in its end of cycle demarcated area point.
   2) The pool cleaner will search and identify the said end of cycle zone location and, while continuing its ordinary cleaning cycle, will travel to that said zone by climbing the wall to the waterline and descending or sinking back to the floor a predefined number of times. A wireless communication messaging may be defined by the user to be implemented on request notifying the end user that it is in its end of cycle demarcated zone.
   3) If a wall climbing exit point was chosen, the pool cleaner may climb to scrub and clean the waterline for a predefined period of time in the app. The end user that may be made aware of this end of cycle procedure by receiving a special communication messaging may opt to retrieve his robot from the pool while the pool cleaner sinks back to the floor and climbs back to the waterline. Failing that, after a number of predefined climbing and descending the pool cleaner will automatically shut-off on the floor within the demarcated end of cycle area point.
g. A special communication messaging option menu may propose to the end user to receive messaging alerts to his device about end of cycle procedure and that the pool cleaner is at the end of its cleaning cycle within the demarcated point area or zone. These said alerts will advise that the pool cleaner is in a finish/home point or an end of cycle mode on the wall. The end user may opt to proceed to extraction and lifting the pool cleaner out of the said demarcated pool zone/area or to restart another pool cleaning cycle. Again, several and repeated such messages may be chosen to be sent to the end user. Failing that, after an “n” amount of attempts have failed, the pool cleaner will automatically shut-off at the pool bottom at the said end of cycle demarcated area point.

The pool cleaner may be held or carried by an integral handle or any other carrying mechanism.

FIG. 7 illustrates method 300 for operating a pool cleaner.

FIG. 7 may start by step 310 of receiving, by the pool cleaner, end of cycle location information that defines an end of cycle location. The end of cycle location information is generated by a mobile computer and under a control of a user.

Additionally or alternatively, the end of cycle information may be pre-programmed to the pool cleaner by its manufactures, field technician and the like. The user may or may not change the pre-programmed end of cycle information.

Therefore—step 310 may be followed by step 312 of altering a cleaning program of the pool cleaner to reflect the end of cycle information. Step 312 may be followed by step 320.

The end of cycle location may include a bottom pool area, and/or may include a pool wall area.

The bottom pool area, and the pool wall area may be of any shape and size. They may be of the same shape and size or may differ from each other by shaper and/or size.

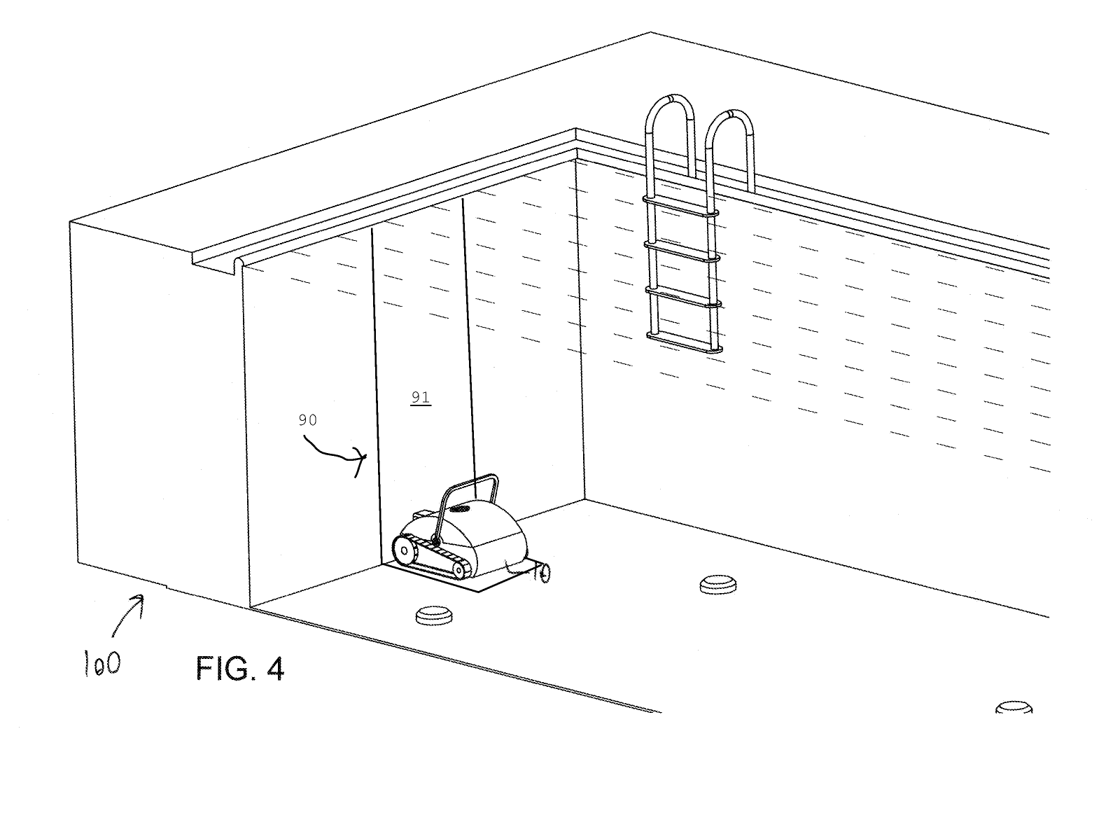

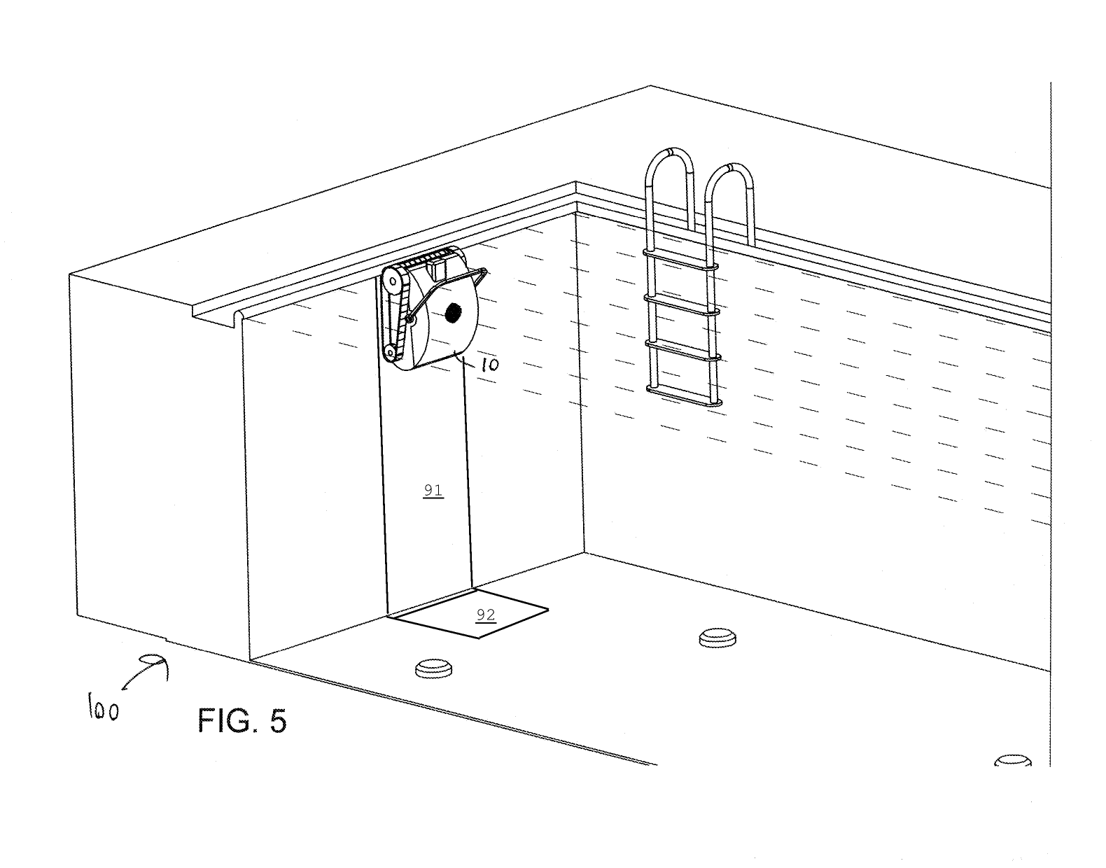

In FIGS. 4 and 5 the end of cycle location 90 includes a bottom pool area 92 and a pool wall area 91.

In FIGS. 4 and 5 the bottom pool area 92 and a pool wall area 91 interface each other. It should be noted that the bottom pool area and a pool wall area may be spaced apart from each other—for example by 1-200 centimetres. For example—a user may want that the bottom pool area is far from the sidewall—so that the user will not enter the pool and step on the pool cleaner.

Step 310 may be followed by step 320 of performing multiple cleaning cycles, by the pool cleaner, wherein the performing comprises positioning the pool cleaner, at an end of each cleaning cycle of the multiple cleaning cycles, at the end of cycle location.

Step 320 may include at least one of the following:
a. Moving, at least once, the pool cleaner along the pool wall area.
b. Cleaning, at least once, the pool wall area while moving, at least once, the pool cleaner along the pool wall area
c. Sending by the pool cleaner and to the mobile computer an end of cycle indication. The sending may occur during the moving.
d. Performing a predefined number of moving and then parking the pool cleaner at the bottom pool area.
e. Mapping the pool by the pool cleaner, using at least one sensor of the pool cleaner.
f. Identifying pool constituents even under severe conditions such as poor visibility, out of balance water chemistry, algae growth causing slippery surfaces and the like.
g. Constructing an imaginary grid of the entire pool area so that specific coordinates may be defined in order for a pool cleaner to reach an end of cycle location, point or area.
h. Providing identification of obstacles in the routing in order to provide modes of either of handling such obstacles for evasive manoeuvres from said obstacles or to construct a coordinate imaginary grid that can be depicted on a screen of a portable computer device and be memorized by the pool cleaner controller.
i. Identifying a meeting with a wall and implementing a program that may be an escape that may translated into a stop forward trajectory and a reversal of forward movement. It may initiate a wall climbing or a temporary or full stoppage at the base of the wall.
j. Climbing a wall thereby resetting various sensors to an expected tilt angle (for example ninety degrees) of the pool cleaner.
k. Using a pool wall as a reference point within the navigational framework of repeatedly finding and defining the end of cycle point area location on the pool floor. Location of this said reference point may also be extended to include recognition of the entire vertical wall strip adjacent to the said horizontal end point area.
l. Identifying and memorizing the pool form and contours using wall recognition, the movement from a horizontal position to a vertical or even a perpendicular position in the pool.
m. Recognizing a co-ordinates grid and thereby the definition of the demarcated end of cycle point or area.
n. Using sensor data (detection signals) and apply one or more algorithms to locate the end of cycle location.
o. Initiating overcoming navigational corrective action procedures to mitigate navigation in adverse pool conditions so that the pool cleaner may specifically reach an end of cycle location consistently and repeatedly towards the end of each cleaning cycle time.
p. Applying a corrective action that involves processing detection signals from one or more gyroscopes and/or one or more compasses about the bearing of the pool cleaner.
q. Climbing on at least a portion of a pool wall by the pool cleaning robot.
r. Cleaning the at least portion of the pool wall by the pool cleaning robot.
s. Climbing on and/or cleaning at least portion of the pool wall that is located outside the end of cycle location. The at least portion of the sidewall may be selected in any manner (random or not) and/or may be fed to the pool cleaner by the user and/or manufacturer and/or technician).
t. Climbing on at least a portion of a pool wall by the pool cleaning robot and using the climbing (especially the position/orientation of the pool cleaner) for calibrating at least one sensor of the pool cleaner. The calibration may involve, for example, climbing to a point of a known slope (for example—vertical) and reading an orientation sensor reading—and correcting the reading if the reading deviates from the known slope.
u. Applying a corrective action that involves processing detection signals from one or more cameras to recognize other constituents such a ladder, a spot lamp or a main drain in order to renew triangulation (or other mapping or finding) of actual location to precisely reach the chosen end of cycle location.
v. Applying a corrective action that involves initiating a lighting of one or more pool area by the one or more lighting modules. The lighting may cause pool constituents to be visible even in pool visibility conditions. This step may include, additionally or alternatively, using detection signals of other sensors in order to renew triangulation of actual location to precisely reach the chosen end of cycle location.
w. Evaluating whether one or more images acquired by the at least one visual sensor disclose one or more pool constitutes—in order to determine whether there is a need to activate the one or more lighting modules.
x. Applying a corrective action that involves initiating a wall climbing upon a meeting with such a constituent. Wall climbing, due to underwater reduced gravity forces, is an advantage that pool cleaners may have over autonomous garden lawnmowers, home vacuum cleaners and the like.
y. Applying a corrective action that involves initiating a combination of a range of sensory means so that the pool cleaner may reach an end of cycle location consistently and repeatedly during each cleaning cycle.

It should be noted that step 310 may include receiving, by the pool cleaner, end of cycle location information that defines an end of cycle location that comprises a bottom pool area and a pool wall area, and that step 320 may include performing a cleaning cycle, by the pool cleaner, wherein the performing comprises moving, at least once, the pool cleaner along the pool wall area.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front”, “back”, “top”, “bottom”, “over”, “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

Any system, apparatus or device referred to this patent application includes at least one hardware component.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for operating a pool cleaner, the method comprises:
receiving, by the pool cleaner, end of cycle location information that defines an end of cycle location; wherein the end of cycle location information is generated by a mobile computer and under a control of a user; and
performing multiple cleaning cycles, by the pool cleaner, wherein the performing comprises positioning the pool cleaner, at an end of each cleaning cycle of the multiple cleaning cycles, at the end of cycle location.

2. The method according to claim 1 wherein the receiving is followed by altering a cleaning program of the pool cleaner to reflect the end of cycle information.

3. The method according to claim 1 wherein the end of cycle location is positioned on a bottom of the pool.

4. The method according to claim 1 wherein the end of cycle location comprises a pool wall area.

5. The method according to claim 1 wherein the end of cycle location comprises a bottom pool area and a pool wall area.

6. The method according to claim 5 wherein the positioning of the pool at the end of cycle location comprises moving, at least once, the pool cleaner along the pool wall area.

7. The method according to claim 6 comprising cleaning, at least once, the pool wall area while moving, at least once, the pool cleaner along the pool wall area.

8. The method according to claim 6 comprising sending by the pool cleaner and to the mobile computer an end of cycle indication, wherein sending occurs during the moving.

9. The method according to claim 6 wherein the moving, at least once, the pool cleaner along the pool wall area comprises performing a predefined number of moving and then parking the pool cleaner at the bottom pool area.

10. The method according to claim 1 comprising mapping the pool by the pool cleaner, using at least one sensor of the pool cleaner.

11. The method according to claim 1, wherein a preforming of each cleaning cycle comprises climbing on at least a portion of a pool wall by the pool cleaning robot.

12. The method according to claim 11, wherein the preforming of each cleaning cycle comprises cleaning the at least portion of the pool wall by the pool cleaning robot.

13. The method according to claim 11, wherein the at least portion of the pool wall is located outside the end of cycle location.

14. The method according to claim 11, wherein the climbing on the at least portion of the pool wall comprises calibrating at least one sensor of the pool cleaner based on a position of the pool cleaner during the climbing or following the climbing.

15. (canceled)

16. (canceled)

17. (canceled)

18. (canceled)

19. A pool cleaner, comprising:
a housing;
an outlet for outputting filtered fluid;
an inlet for receiving non-filtered fluid;
a controller;
a filtering unit;
a propulsion system;
one or more sensors; and
a communication module;
wherein the communication module is configured to receive end of cycle location information that defines an end of cycle location; wherein the end of cycle location information is generated by a mobile computer and under a control of a user; and
wherein the controller is configured to control multiple cleaning cycles of the pool cleaner; wherein a performing of the multiple cleaning cycles comprises positioning the pool cleaner, at an end of each cleaning cycle of the multiple cleaning cycles, at the end of cycle location; wherein each cleaning cycle comprises passing the non-filtered fluid through the filtering unit to provide the filtered fluid while moving the pool cleaner by the propulsion system.

20. (canceled)

21. A non-transitory computer readable medium that stores instructions that once executed by a pool cleaner, causes the pool cleaner to perform the steps of:
receiving end of cycle location information that defines an end of cycle location; wherein the end of cycle location information is generated by a mobile computer and under a control of a user; and
performing multiple cleaning cycles, wherein the performing comprises positioning the pool cleaner, at an end of each cleaning cycle of the multiple cleaning cycles, at the end of cycle location.

22. (canceled)
